(19) United States
(12) Patent Application Publication
(10) Pub. No.: US 2006/0292046 A1
(43) Pub. Date: Dec. 28, 2006

(54) Oxidation process and reactor with modified feed system

(75) Inventors: Olan Stanley Fruchey, Houston, TX (US); Brian Robert Keyes, Houston, TX (US); Carl David Murphy, Sandia, TX (US)

Correspondence Address: THE DOW CHEMICAL COMPANY, INTELLECTUAL PROPERTY SECTION,, P. O. BOX 1967, MIDLAND, MI, 48641-1967, US

(73) Assignee: DOW GLOBAL TECHNOLOGIES INC., Midland, MI (US)

(21) Appl. No.: 10/565,923

(22) PCT Filed: Jul. 31, 2003
(86) PCT No.: PCT/US03/23933

§ 371 Date: Jan. 25, 2006

(51) Int. Cl. F28D 7/00; B01J 10/00

(52) U.S. Cl. 422/197; 422/201

(57) ABSTRACT

In an oxidation process in a shell and tube reactor (10), an improvement is disposing a short bed of packing material (30) about the tube (50) inlets. The short bed operates to direct contaminants derived from heat exchange media away from the headspace (20) and thus prevents formation of combustible gas mixtures.

### TECHNICAL FIELD

This invention relates to improvements for processes using shell and tube reactors. More specifically, the invention relates to using a short bed of packing material to direct leakage of contaminants such as heat exchange media or derivatives thereof away from the headspace of a tubular reactor and prevent formation of combustible gas mixtures.

### BACKGROUND

Tubular reactors are often times used for exothermic reactions, for example, the oxidation of propylene to acrylic acid and the manufacture of maleic anhydride. Typically, production of acrylic acid is a two-stage gaseous catalytic oxidation of propylene. The method employs a first stage reactor with a first stage catalyst for oxidation of propylene to acrolein and a second stage reactor charged with a second stage catalyst suitable for oxidation of acrolein to acrylic acid. Generally, admixed feed reactants, for example, propylene, air and steam used to produce acrylic acid are not expected to ignite at temperatures lower than about 450° C. Notwithstanding, auto-ignition can occur at relatively low temperatures if feed reactants contain substantial amounts of contaminants. Such an ignition can damage equipment, wastefully consume raw materials, interrupt otherwise continuous reaction cycles, and so forth.

Temperature regulation and suppression of hot spots have been addressed in U.S. Pat. No. 5,719,318. In that process for production of acrylic acid, hot spots or build up of heat is suppressed in the catalyst layers of reaction tubes by using a varying range of sized particles, preferably catalyst-containing particles.

U.S. Pat. No. 4,921,681 discloses a method to reduce ethylene oxide loss and risk of uncontrolled localized burning near the outlet of an ethylene oxide reactor by packing inert particles in tubes, downstream of catalysts.

U.S. Pat. No. 5,080,872 discloses a method of regulating temperature inside a reaction vessel using a bed of solid particles having varied temperature zones through which a reactant fluid phase is passed.

U.S. Pat. No. 6,028,220 discloses to the oxidation of propylene during which there is a reduction of hot spots in the catalyst layer by varying the catalyst activity; whereas,

U.S. Pat. No. 6,563,000 describes a process of producing acrylic acid from acrolein that includes multiple reaction zones wherein each such reaction zone comprises a catalyst of a different activity level, as compared to an adjacent zone, as is well known.

Controlling temperature by circulating particulate matter, in general, has been disclosed, see, for example, U.S. Pat. No. 4,594,967 which discloses use of circulating particulates to cool the reaction in a fluidized bed reactor while also possibly converting calcium sulfide to calcium sulfate. U.S. Pat. No. 4,672,918 discloses circulating temperature controlled solids to control the temperature of a fluidized bed. U.S. Pat. No. 4,899,695 discloses a process for controlling heat transfer and erosion in a fluidized bed combustion reactor by introducing particles into the combustion unit along with or in the presence of combustion reactants whereby some of the particles may be recycled. U.S. Pat. No. 5,505,907 describing a method for controlling the temperature of an incoming gas stream by incorporating coated solid particles into the gas stream, circulating and separating such particles and thereafter recycling same for repeat use. United States Patent Application No. 2002/0191732 discloses the use of circulating suspended solids to control temperature; and United Stats Patent Application No. 2002/0048537 which discloses a process for the polymerization of olefins wherein solid particles are circulated by a compressor. So also, ceramic balls have been used to pack the interstage space of two-stage reactors to act as a heat sink.

The foregoing art, however, does not address the problem of contamination or adulteration of reactor feed.

Removal of contaminants has been described, for example, in U.S. Pat. No. 4,029,636 which discloses a method for removing molybdenum trioxide from reactor effluent gases issuing from reactors containing molybdenum-based catalysts by causing the effluent gases to pass over a bed of cooled solids located at the exit end of the tubular reactor on which the molybdenum trioxide is deposited. U.S. Pat. No. 5,413,699 discloses removal of NOₓ by forcing NOₓ containing gas through a DeNOₓ catalyst bed. Finally, U.S. Pat. No. 5,538,544 discloses a pressure swing adsorption system whereby a gas is introduced into the vessel head of such a pressure swing system and caused to distribute uniformly on an adsorbent bed as a result of passing through a graded ball bed support system.

The methods described above for controlling contamination require somewhat specialized environments and/or construction and use, and accordingly, they are simply not practical for retrofitting existing equipment to limit contamination in the event of a reactor breach, for example, where heat exchange fluid may leak and form derivatives and mix with the reactor feed.

### SUMMARY

The invention is based, in part, on the discovery that a short bed of packing material in the vicinity of the inlets of reactor tubes of a shell and tube reactor can restrict migration of decomposition gases (i.e., NOx) from heat exchange media into the reactor headspace. It has been found that such a bed placement virtually eliminates auto-ignition problems stemming from heat-exchange media leaks. It has been found that a short bed suffices to ameliorate contaminant problems without the need for a deeper bed and its associated pressure drop and material expense.

Generally, the invention relates to an improved process for high temperature oxidation of a gaseous reactant in a shell and tube reactor of the class with a plurality of reactor tubes wherein the reactor tubes are immersed in a heat exchange medium contained within the shell and the interior volume of the reactor tubes is thereby isolated from the heat exchange medium. Typically, the reactor tube interior inlets are in communication with a feed plenum or headspace having a characteristic cross-sectional area in the vicinity of the reactor tube inlets generally free from obstruction, such that the velocity of a feed gas mixture to the reactor tube inlets is the volume rate of flow of the feed gas mixture divided by the characteristic cross-sectional area of the plenum in the vicinity of the reactor tube inlets. The process is also of the class wherein the feed gas mixture is fed from the plenum to the reactor tubes. The improvement of the present invention includes disposing a short bed of packing material adjacent to the reactor tube inlets. The short bed can include a voidage of from about 0.3 to about 0.75 to increase the velocity of the feed gas mixture in the vicinity of the reactor tube inlets whereby contamination of the feed plenum by the decomposition gases of the heat exchange medium is controlled in the event of a reactor breach in the vicinity of the reactor tube inlets, as might occur when heat exchange medium leaks between the tubes and end plate due to corrosion. Typically, the short bed occupies less than 20 percent of the headspace volume and preferably less than about 10 percent of the headspace volume.

Preferably, the packing material comprises spherical macroparticles having diameters from about 0.125 to about 4 inches. Most preferred are ceramic macroparticles having a diameter of less than about 2 inches. Alternate packing material shapes may be selected from pellets, disks, rods and plates of various shapes. DENSTONE® balls, available from Norton (Akron, Ohio, USA) are particularly preferred. The inventive process and apparatus may be used in connection with the manufacture of methacrylic acid, maleic anhydride, acrylic acid and potentially other partial oxidations as may occur in the manufacture of ethylene oxide or vinyl acetate monomer, for example.

In another aspect of the invention, there is provided an improvement to a shell and tube reactor having tubes immersed in a heat-exchange medium at a temperature of 200-400° C. which includes adding a short bed of packing material about the reactor tube inlets as described below. The short bed has a depth of from about 10 to about 25 inches, while the reactor tubes have an inside diameter of about 0.75 to about 2 inches in preferred embodiments. The improved reactor is suitably employed in the manufacture of acrylic acid as described below.

Controlling contaminants, for example, oxidizers such as nitrogen oxides, can control flammability and undesired spontaneous auto-ignition. Adequate flow velocity prevents temperature excursions when the feed gas mixture and contaminants combine to form a mixture of increased flammability. So also, the bed placement could prevent undesirable migration of contaminants to the headspace whether or not contaminants increase flammability. For example, a contaminant could be a catalyst poison, thus, the contaminant needs to be restricted to localized regions of the reactor rather than be ubiquitous in the headspace so that it is fed to all of the tubes.

Other features and advantages of the invention will be apparent from the following detailed description, and from the claims.

### DESCRIPTION OF DRAWINGS

FIG. 1 is a schematic diagram illustrating the process and apparatus of the present invention.

FIG. 2 is a graph illustrating the spontaneous ignition of feed gas stream in the presence of 0.2% NO.

Like reference symbols in the various drawings indicate like elements.

### DETAILED DESCRIPTION

Typically, steel shell and tube reactors with a heat exchange medium are used in exothermic reactions, to remove heat of reaction. In very high temperature processes, salts are used as heat exchange media to remove the heat of reaction. Without being bound by a theory, Applicants believe that anions in salts in the heat exchange medium can react with iron oxide formed on the reactor tubes. The anions, for example, nitrates and nitrites may decompose to generate nitrogen oxides in the presence of iron oxide in the area of a leak, as described by J. C. Casanova, “Thermal decomposition of sodium nitrate; Part I-Thermogravimetric study, with data, of the reaction of nitric oxide with sodium oxide. Part II-Systematic analytical study of the reaction in the presence of iron oxide”, Bull. Soc. Chim, France (1959) pp. 429-440, which is incorporated herein by reference in its entirety. Nitrogen oxides can include nitric oxide (NO), nitrous oxide (N₂O), and nitrogen dioxide (NO₂) among others. Presence of nitrogen oxides in low levels, for example, 10 to 9000 ppm can act as an oxidizer and lower ignition temperature of the feed gas mixture as may occur when the heat exchange medium leaks into the headspace. For example, a feed gas mixture of 7% propylene/60% air/30% steam is stable at a temperature of about 450° C. Presence of 5000 ppm of nitrogen oxides can lower the ignition temperature to, for example, 300° C. Presence of a short bed of packing material adjacent to the reactor tube inlets may prevent migration of contaminants into the headspace, or quench autoignition in the presence of nitrogen oxides or decrease residence time of combustible mixture in the reactor or confine the contaminants to the area where the leakage occurred or alternatively, alter the temperature profile of the reactor. Regardless of theory, the short bed has been found remarkably effective in ameliorating autoignition problems.

As used herein, “macroparticle” is any solid three-dimensional object having a volume of at least about 0.015 ml or more; preferably more than about 0.1 ml or more. For reference, note that a ¼″ diameter spherical particle has a volume of about 0.13 ml.

As used herein, “voidage” is the volume ratio of interstitial spaces in a bed of material to the total volume of bed (material plus free space therein).

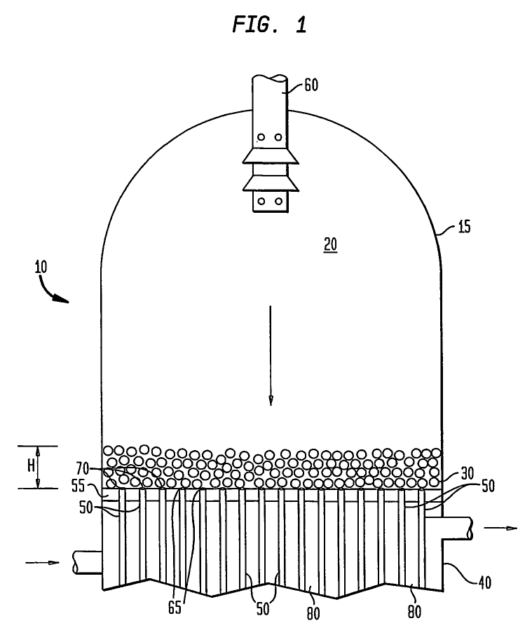

Referring to the drawings, FIG. 1 shows a shell and tube reactor 10, which includes a head 15 defining a feed plenum or headspace 20, a short bed of packing material 30, a heat exchanger shell 40 and a plurality of reactor tubes 50 disposed in the reactor. The feed plenum includes a distributor 60 for admixing reactants in a feed gas mixture. The feed plenum 20 is in communication with the plurality of reactor tubes 50 in a heat exchanger 40, through an end plate 55. The dimensions of the feed plenum or headspace 20 can vary with the cross-section area of the reactor tubes in the reactor 10. For example, the feed plenum can be from about 5 to about 14 feet tall, with a diameter of the feed plenum from about 2 to about 20 feet. The plurality of reactor tubes 50 with reactor tube inlets 70 are surrounded by a heat exchanger medium 80. For example, the heat exchange medium 80 can be a salt. Typically, the salt coolant can include melts of salts. Suitable salts include potassium nitrate, potassium nitrite, sodium nitrite and/or sodium nitrate or metals having a low melting point, for example, sodium, mercury or alloys of various metals. The temperature of the heat exchange medium can be less than 450° C., more preferably about 420° C. Specifically, Dupont's HITEC salt can be used, which includes about 53% potassium nitrate, about 40% sodium nitrate, and about 7% sodium nitrate. Contaminants formed by decomposition of anions in salt coolant can leak through the end plate area 65 into the feed plenum 20 in the event of a reactor break. It is believed that the salt leaks first and then decomposes in the presence of rust and oxidation catalyst.

The short bed of packed material 30 is disposed adjacent to the reactor tube inlets 70, extending horizontally in the plenum. The short bed 30 includes discrete inert macroparticles of, for example, ceramic material. The short bed of packing material 30 can vary in dimensions. Suitable depth, H, of the short bed can be less than 24 inches or so but at least 5 inches; typically, 1 foot or so. Shape of such inert macroparticles is not critical. For example, the macroparticles may be granular, such as a sphere, pellet, disk, hollow tube, spherical, cylindrical, ring-formed, or may be in the forms of rods, plates, and wire net or in the form of aggregates thereof Suitable macroparticles can be spheres. When granular or other inert substances are used, their sizes are not necessarily uniform. Preferably, however, when a sphere inert substance is used, the diameter of the sphere can be from about 1/16 inch to about 2 inches, preferably about 0.25 inch diameter. It will be appreciated that the size of the macroparticles is most preferably not larger than the diameter of reactor tubes (ca. 1″) in the reactor, so as to not occlude the reactor tubes.

The short bed 30 has a substantial voidage so as not to cause too much of a pressure drop or pressure differential during the passage of feed gas mixture to the reactor tubes. The voidage of the macroparticles in the short bed 30 can be from about 0.25 to about 0.75, preferably from about 0.3 to 0.5 and most preferably 0.4. The packing density of the macroparticles can be from about 70 lbs/ft³ to about 10 lbs/ft³, with from about 80-90 lbs/ft³ being somewhat typical. Specifically, the spheres can be, for example, DENSTONE® spheres, which are commercially available for Norton Chemicals (Akron, Ohio, USA). In various embodiments, the DENSTONE® spheres can be, for example, DENSTONE®57, DENSTONE® 2000 or DENSTONE® 99. The macroparticles can be ceramic, alumina, silica or clay in composition.

The short bed of packed material 30 provides an increase in velocity of the feed gas mixture to the reactor tube inlets because the cross section available for flow is decreased by the area occupied by the macroparticles. Such an increase in velocity of the feed gas mixture sweeps contaminants such as oxidizers, for example, nitrogen oxides, stemming from end plate breaches into the reactor tubes 50 before they migrate into the plenum generally. Adequate flow velocity and a streamlined flow path can reduce flammability in the feed plenum 20, where the feed gas mixture and contaminants can mix to cause a potential spontaneous ignition of the feed gas mixture. Spontaneous auto-ignition can be controlled by passing the feed gas mixture to the reactor tubes in a time that is less than the time required for auto-ignition.

In general, a method for producing acrylic acid from propylene in a two-stage catalytic oxidation using shell-and-tube heat exchanger type reactor have been described. See, for example, U.S. Pat. Nos. 6,545,178, 6,482,981, and 6,069,271, which are incorporated herein by reference in their entirety.

Referring again to FIG. 1, in a process for making such products, the distributor 60 conveys a feed gas mixture of reactants into the feed plenum or headspace 20. The feed gas mixture expands into and through the feed plenum 20 to the short bed of packed material 30. The superficial velocity of the feed gas mixture into the feed plenum can be in the range of 3 to 10 ft/sec. For example, the feed gas mixture can include 7% propylene/60% air/30% steam. The feed gas mixture enters the short bed of packed material 30 adjacent to the reactor tubes inlets 70 of the reactor. Optimum pacldng material can be determined by the size of the tubular reactor, gas flow combination, flow through the inlet plenum, desired pressure drop and velocity profile in the short bed.

In another embodiment of the invention, referring to FIG. 1, a feed gas mixture including n-butane, and air passes via distributor 60 to feed plenum 20. The feed gas mixture is distributed uniformly over the short bed of packing material 30 and passes to the reactor tubes 50. In passing through reactor 10, n-butane reacts with oxygen in the air to produce maleic anhydride.

In still another embodiment of the invention, referring to FIG. 1, a feed gas mixture including isobutylene, and air passes via distributor 60 to feed plenum 20. The feed gas mixture is distributed uniformly over the short bed of packing material 30 and passes to the reactor tubes 50. In passing through reactor tubes, isobutylene reacts with oxygen in the air to produce methacrylic acid.

Still other products, such as vinyl acetate or ethylene oxide may be made in accordance with the present invention.

The features of the present invention are further illustrated by the following examples, which are given for illustrations of the invention and are not intended to be limiting thereof.

### COMPARATIVE EXAMPLE

In a process for oxidation of propylene to acrylic acid, a tubular reactor including a plurality of reactor tubes having a cross-sectional area of (ca. 60 ft² open tube area; ca. 200 ft² top head area), and length of 20 ft (includes cool down zone) was operated at temperature of 620° F.; 326° C. and a pressure of ca. 16 psig; 1.1 bar gauge with a composition of the feed gas mixture being ca. 7% propylene, ca. 60% air and ca. 30% steam. The system was operated such that a gas flow of roughly 1200 MSCFH was obtained. The reactor appeared to have leakage problems where contaminants from the heat exchange medium to the headspace of the reactor changed the flammability of the feed. The reactor was shut down due to episodes of auto-ignition of the gas feed mixture in the headspace. Reactor tubes were cooled by means of a salt coolant bath of Dupont HITEC salt which was believed to be a source of contamination.

### Example 1

The reactor of the comparative example above was charged with a short bed of packing material of DENSTONE® ¼″ spheres. The depth of the short bed of packing material was 1 ft. The reactor conditions were selected such that a temperature of ca. 620° F.; 326° C. and a pressure of ca. 16 psig; 1.1 bar gauge prevailed in the reactor with a composition of the feed gas mixture being ca. 7% propylene, ca. 60% air and ca. 30% steam. The system was operated such that a circulating volume gas flow of ca. 1200 MSCFH was obtained. Autoignition of the feed was virtually eliminated by placement of the short bed about the reactor tube inlets, while yields and conversions were unchanged.

### Example 2

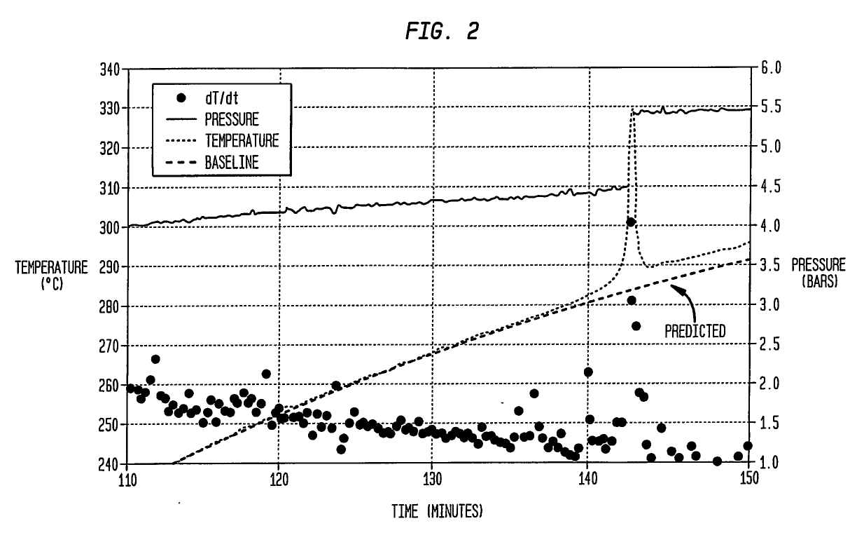

Spontaneous ignition of a feed gas mixture of propylene/air/water in the presence of nitrogen oxides was evaluated using a modified ASTM G72-82 (reapproved in 1996) method. A one-liter stainless steel vessel with circumferential heaters was loaded with a sample of feed gas mixture of 6.7% propylene, 61.3% air, 31.8% steam and 0.2% NO. As shown in FIG. 2, the temperature (° C.) was monitored as a function of time (minutes) and pressure (bara). Referring to FIG. 2, the results show that spontaneous ignition occurred at about 280° C., in contrast to a feed gas mixture without NO which was non-flammable at 450° C.

Other embodiments are within the scope of the following claims.

1. In a process for high temperature oxidation of a gaseous reactant in a shell and tube reactor of the class with a plurality of reactor tubes wherein the reactor tubes are immersed in a heat exchange medium contained within the shell and the interior volume of the reactor tubes is thereby isolated from the heat exchange medium and wherein reactor tube interior inlets are in communication with a feed plenum having a characteristic cross-sectional area in the vicinity of the reactor tube inlets generally free from obstruction, such that the velocity of a feed gas mixture to the reactor tube inlets is the volume rate of flow of the feed gas mixture divided by the characteristic cross-sectional area of the plenum in the vicinity of the reactor tubes, the process being generally of the class wherein the feed gas mixture is fed from the plenum to the reactor tubes, the improvement comprises:
disposing a short bed of packing material adjacent to the reactor tube inlets, and wherein the short bed occupies less than about 20 percent of the volume of the feed plenum and
wherein the short bed has a voidage of from about 0.3 to about 0.75 and is thereby operative to increase the velocity of the feed gas mixture in the vicinity of the reactor tube inlets whereby contamination of the feed plenum by the heat exchange medium is controlled in the event of a reactor breach in the vicinity of the reactor tube inlets.

2. The method according to claim 1, wherein the packing material comprises macroparticles.

3. The method according to claim 1, wherein each macroparticle is from about 0.125 inches in diameter to about 4 inches in diameter.

4. The method according to claim 3, wherein each macroparticle is less than about 2 inches in diameter.

5. The method according to claim 1, wherein the macroparticles comprise ceramic macroparticles.

6. The method according to claim 2, wherein the macroparticles are substantially spherical in shape and have an average diameter of from about 0.125 to about 4 inches.

7. The method according to claim 2, wherein the macroparticles are selected front a group consisting of spheres, pellets disks, hollow tubes, rods and plates.

8. The method according to claim 7, wherein the macroparticles are spheres.

9. The method according to claim 8, wherein the spheres are DENSTONE balls.

10. The method according to claim 9, wherein the DENSTONE balls are selected from the group consisting of DENSTONE 57, DENSTONE 2000 and DENSTONE 99.

11. The method according to claim 1, wherein the oxidation reaction comprises oxidation of isobutylene to methacrylic acid.

12. The method according to claim 1, wherein the oxidation reaction comprises oxidation of butane to maleic anhydride.

13. The method according to claim 1, wherein the oxidation reaction comprises oxidation of propylene.

14. The method according to claim 1, wherein the heat exchange medium is a molten salt coolant.

15. The method according to claim 14, wherein the salt is a HITEC salt.

16. The method according to claim 15, wherein the salt is about 53% potassium nitrate, about 40% sodium nitrite, and about 7% sodium nitrate.

17. The method according to claim 1, wherein the short bed occupies less than about 10 percent of the volume of the feed plenum.

18. In an apparatus for high temperature oxidation of a gaseous reactant in a shell and tube reactor configured for flowing a feed gas mixture to the tubular reactor through a distributor, and directing the feed gas mixture from a feed plenum to a plurality of reactor tubes through their inlets communicating with the feed plenum, the reaction tubes being immersed in a heat-exchange medium at a temperature of from about 200° C. to about 400° C., the improvement which comprises:
a short bed of packing material adjacent to the reactor tube inlets wherein the short bed has a voidage of from about 0.3 to about 0.75, whereby contamination of the feed plenum by any decomposition gases of the heat exchange medium is controlled in the event of a reactor breach in the vicinity of reactor tube inlets, and wherein the short bed occupies less than about 20 percent of the volume of the feed plenum.

19. The apparatus according to claim 18, wherein diameter of each reaction tube is from about 0.75 inches to about 2 inches.

20. The apparatus according to claim 18, wherein depth of the short bed of packing material is from about 10 inches to about 25 inches.

21. The apparatus according to claim 20, wherein depth of short bed is at least 10 inches.

22. In a method for manufacturing acrylic acid in a shell and tube reactor for oxidizing propylene comprising flowing a feed gas mixture to a feed plenum through a distributor, and directing the feed gas mixture from the feed plenum to a plurality of reactor tubes disposed in the shell and tube reactor, the reactor tubes being immersed in a molten salt coolant at a temperature of from about 200° C. to about 400° C., the improvement which comprises:
providing a short bed of packing material adjacent to reactor tube inlets of the reactor tubes wherein the short bed occupies less than about 20 percent of the volume of the feed plenum; and
contacting the feed gas mixture with the short bed.
